(19) United States
(12) Patent Application Publication
(10) Pub. No.: US 2013/0086186 A1
(43) Pub. Date: Apr. 4, 2013

(54) COMPUTER IMPLEMENTED METHOD FOR COLLECTION, AGGREGATION AND AUTHENTICATION OF ELECTRONIC DATA

(71) Applicant: RPOST COMMUNICATIONS LIMITED, Pembroke (BM)

(72) Inventor: Terrance A. Tomkow, Los Angeles, CA (US)

(73) Assignee: RPOST COMMUNICATIONS LIMITED, Pembroke (BM)

(21) Appl. No.: 13/624,801

(22) Filed: Sep. 21, 2012

Related U.S. Application Data
(60) Provisional application No. 61/538,713, filed on Sep. 23, 2011.

(51) Int. Cl. G06F 17/24

(52) U.S. Cl. CPC G06F 17/243; H04L 51/10
USPC 709/206; 715/225

(57) ABSTRACT

A method for the collection, aggregation and authentication of data comprises the storage of blank copies of a specially pre-prepared form at a server, the distribution of copies of the form to remote users by email or web download, the input of data to the forms by remote users, the electronic submission of the data to the server; the transmission of a message to remote users' email address requesting a confirmation of signing, the confirmation including the collection of information identifying the remote user to the server, the incorporation of the data transmitted from the remote user into the copy of the form stored at the server and the return of a filled out and authenticated form to an email address designated for the receipt of the data.

### CROSS-REFERENCES TO RELATED APPLICATIONS

This application claims the benefit of priority from Provisional Application No. 61/538,713, filed Sep. 23, 2012, incorporated by reference in its entirety.

### FIELD OF DISCLOSURE

The present disclosure relates to the field of data collection. More particularly this disclosure relates to collecting, authenticating and aggregating data using electronic forms distributed to a plurality of remote users.

### BACKGROUND

The internet has dramatically changed the way the information is presented/collected from users. Collecting user's data plays a vital role in consumer driven segments such as the FMCG industry, cosmetics industry and the like. However, eliciting responses from a large consumer base involving thousands of users is a cumbersome task given the fact that the consumer base is dispersed over a large geographic terrain. Moreover, the fact that thousands of users have to be contacted to elicit data makes the task of data collection much tougher.

In the event that users dispersed over a larger geographical area are to be consulted for the purpose of eliciting data, all the users are sent individual paper based questionnaires since it is not practically feasible to bring thousands of users under one roof. The disadvantage with using paper based questionnaires is that it contributes to deforestation/loss of trees since large amounts of paper are required. Further, scrutinizing so many pages of data, aggregating them and arriving at a conclusion based on the data once again requires a large amount of man power and also consumes a great deal of time.

Therefore, in order to mitigate the aforementioned issues, online data collection systems were introduced. Online data collection systems provide a user with a plurality of questions with the aim of eliciting appropriate responses from those users. However, in these online data collection methods, the data provided by users is not authenticated. These surveys are open-ended and there is no scrutiny of the participants (users) involved in the process of data collection.

Therefore, there is a need for a system and method that mitigates the issues associated with conventional paper based data collection systems and online data collection systems and provides for authentication of respondents to a survey. The present invention satisfies these and other needs.

### SUMMARY OF THE INVENTION

In its most general aspect, the present invention envisages a system and method for collection, aggregation and authentication of electronic data provided by remote users through distributed electronic forms. In one aspect, a method in accordance with the present invention includes the computer implemented steps of: creating an electronic form having a plurality of data fields to be completed by remote users; storing the electronic form in a server; at the server, associating the electronic form with at least one email address to which the electronic form is to be transmitted; configuring the electronic form to electronically transmit the contents filled in the plurality of data fields to the server; distributing replicas of the electronic form to a plurality of remote users; prompting the plurality of remote users to fill-in the fields of the electronic form; transmitting the electronic form along with the data filled-in the data fields of the electronic form, to the server; at the server, retrieving the data from the respective data fields of the electronic form and inserting the retrieved data into the data fields of the electronic form stored at the server; and transmitting a replica of the electronic form containing completed/filled-in data fields, to the email address.

In another aspect, the present invention includes receiving at the server, an email address corresponding to a requesting user to whom the electronic form containing completed/filled-in data fields, is to be sent; sending a message to the requesting user for confirming the identity of the requesting user; and transmitting the completed/filled-in electronic form to the requesting user only in the event a confirmation of the identity of the remote user is received by the server.

In another aspect, the step of sending a message to the requesting user for confirming the identity of the requesting user further includes the step of sending an email message to the requesting user.

In still another aspect, the method envisaged by the present invention may include the step of transmitting the completed/filled-in electronic form to the requesting user further includes the step of transmitting the completed/filled-in form as an attachment to an email message.

In yet another aspect, the method further includes the step of transmitting the electronic form to an internet based website/web service.

In still another aspect, the method further includes the following computer implemented steps: generating a unique identification code corresponding to the electronic form completed/filled-in by a remote user; and embedding the identification code in the message transmitted to the remote user for confirmation of identity of the remote user. In a further aspect, the computer implemented method includes the step receiving a reply from the remote user filling-in/completing the electronic form, in the form of return email message.

In another further aspect, the computer implemented method further includes the step of embedding a web link into the email message sent to the remote user for confirmation of identity. In yet another further aspect, the method further includes the step of pointing/referring through the web link, to a unique identification code corresponding to the electronic form completed/filled-in by the remote user.

In another aspect, the method further includes the step of prompting the remote user to visit a website associated with the server to provide indications of identity.

In still another aspect, the computer implemented method further includes the following computer implemented steps: prompting the remote user filling/completing the electronic form, to draw a signature in a web-interface as an indication of the remote user's identity; and recording a copy of the signature at the server as a confirmation of the identity of the remote user.

In yet another aspect, the method further includes the step of embedding the unique identification code in the return email message sent by the remote user confirming his/her identity. In still another aspect, the method further includes the step of including indicia confirming the identity of the remote user in the copy of the filled-in/completed form transmitted to the requesting user designated to receive the filled-in/completed electronic form.

In another aspect, the method further includes the step of creating a digital signature on the combination of filled-in/completed electronic form along with indications of the identity of the remote user filling/completing the form, prior to transmitting the electronic form to the designated requesting user.

In another aspect, the method includes the step of associating a time stamp indicative of the time the completed/filled-in electronic form is transmitted to the designated requesting user.

In still another aspect, the method further includes the step of basing the electronic form upon Portable Document Format (PDF).

In other aspects, the present invention provides a method that enables collection and aggregation of data obtained from remote users that can be seamlessly integrated with currently available data collection methods and provides a method that facilitates easy collection of data from remote users.

In another aspect, the method of the present invention provides a method that generates a unique identification code uniquely identifying the data provided by a user, and, in another aspect, also provides a method that facilitates authentication of a remote user's identity before sending the acquired data. In still another aspect, the method prompts the user providing the data to draw a signature in a web-interface as an indication of the user's identity.

In another aspect, the present invention includes a system programmed using appropriate software commands to carry out the various steps of the aspects described above.

Other features and advantages of the invention will become apparent from the following detailed description, taken in conjunction with the accompanying drawings, which illustrate, by way of example, the features of the invention.

### BRIEF DESCRIPTION OF THE DRAWINGS

The invention will now be described with reference to the non-limiting drawings in which:

FIG. 1 illustrates a schematic of a computer implemented system for collection, aggregation and authentication of data; and

FIG. 2 and FIG. 3 illustrate a flowchart corresponding to the computer implemented method for collection, aggregation and authentication of data.

### DETAILED DESCRIPTION OF THE PREFERRED EMBODIMENTS

The system and method of the present invention is explained with reference to collecting information and data and then authenticating the information and data through distributed electronic forms. The forms are distributed through network architecture necessary for the implementation of electronically distributing the forms and retrieving information provided by a user who fills in various fields in the form with data. It is to be understood that such an explanation is only for the purpose of illustration. The system and method envisaged by the present disclosure can be applied to other protocols and other message types without departing from the scope of the disclosure.

It will be understood by those skilled in the art of message and data transmission over networks that the various embodiments of the present invention may be implemented using servers, processors, data storage and various software programs, such as email systems, network protocols, HTML systems and the like as are known by those skilled in the art. For example, a server such as is described below will typically include one or more processors that are controlled by software programs to carry out the various steps described. Such a server will include communication ports for communication of data to and from the server. The communication port may also allow for information to be stored by the processor of server onto a data storage device, which may be any data storage or memory device known in the art. The processor may also communicate over a network, which may be wired or wireless, so as to implement the various embodiments of the present invention.

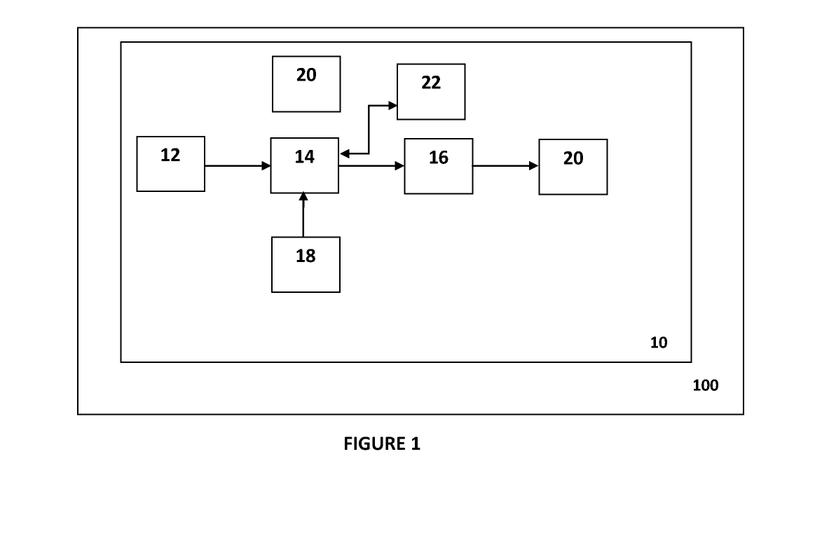

Referring to FIG. 1, there is shown a system 100 for collection, aggregation and authentication of data provided by remotely located users through distributed electronic forms. The electronic forms are typically in the form of portable document format (PDF). However, the PDF has been used only for the purpose of illustrating the system and method of the present disclosure. It is to be understood that the system and method of the present disclosure also works on documents in other formats including but not restricted to Microsoft WORD, Microsoft EXCEL, HTML based web pages and the like.

Referring again to FIG. 1, there is shown a server 10 comprising a creation module 12. The creation module 12 is configured to create an electronic form comprising a plurality of data fields. The creation module 12 typically creates the electronic form in PDF (Portable Document Format). However, it is possible for the creation module to create electronic forms in other forms including but not restricted to Microsoft WORD, Microsoft EXCEL, HTML web page and the like.

The electronic form created by the creation module is stored in a repository 14 housed in the server 10. At the server 10, replicas of the stored electronic form are created and stored in the repository 14. Further, at the server 10, an association module (not shown in the figures) associates each of the replicas of the electronic forms with an email address, thereby creating a one-to-one association between each of the replicas of the electronic form and corresponding email addresses. Subsequently, each of the replicated electronic forms are to be transmitted to the respective email addresses via a transmission module 16. The association module also associates a destination email address to the original electronic for storage in the repository 14 of the server. The original electronic form is required to be sent to the destination email address after being updated by a plurality of users who in turn have access to the replicas of the electronic form.

Further, at the server 10, subsequent to creating a one-to-one association between the replicas of the electronic form and the corresponding email addresses, the electronic forms are configured by a configuring module 18 to transmit the data included in the data fields of respective electronic forms. Subsequently, a distributing module 20 distributes the electronic forms by transmitting them to the designated email addresses with which the electronic forms were associated earlier. The electronic forms are made accessible to users via their network enabled device such as PDAs, laptop computers, desktop computers, mobile phones and smart phones.

Once the electronic forms are available to users (remote users) for access, the users are prompted via their respective network enabled devices, to fill-in/complete the data fields of the received electronic form. Typically, users use their respective handheld devices to view and fill up the electronic forms. Subsequently, the electronic forms filled up/completed by respective users are transmitted back to the server 10 using well known network architectures.

Subsequently, at the server 10, the data provided in the data fields of respective forms are retrieved by a retrieving module 22 and stored in the repository 14. The data retrieved from the respective electronic forms are copied on to the data fields of the electronic form stored in the server 10. Subsequently, the electronic form stored at the server 10 is updated with data from the respective electronic forms obtained from respective users. Further, the updated electronic form is transmitted to the designated email address, typically in the form of an attachment to an email message.

In an embodiment of the present invention, the user having the designated email address with which the original electronic form is associated is required to prove his/her identity for having access to the original electronic form filled up/completed with the data provided by respective users. In order to ascertain the identity of the user, the MTA (mail transfer agent) of the server 10 transmits another message, also referred to as a ‘notification,’ to the corresponding user asking for the user's confirmation of the identity. Typically the notification is sent in the form of an email message to the user (user to whom the completed electronic form is to be sent) from the server 10. The server 10 modifies certain headers of the notification message in order to make sure that the user's reply to the notification is sent to a place from where the server 10 can access and process the reply, and also to ensure that an appropriate reply is elicited from the sender. For example, if the name of the sender is ‘john smith’, and his web address is johnsmith@adomain.com', the server sends the notification to'johnsmith@adomain.com'. The address of john smith is included in the ‘TO’ column of the notification message. Further, the server 10 automatically modifies some of the headers of the notification message to ensure that the reply from john smith is always accessible to the server 10 for processing. The notification message is sent to john smith's MUA (Mail User Agent) which is in turn requested to send the reply from john smith to an address specified by and accessible to the server 10 for processing. Subsequently, the user replies to the notification message sent by the server 10, and confirms his/her identity by typically sending a return email to the server. Subsequent to receiving the confirmation about the identity of the user, the server 10 transmits the electronic form filled up with data received from remote users to the user.

The notification message transmitted from the server 10 to the user prompts the user to provide indications of his/her identity to the server 10. The user can indicate his identity by drawing/creating a digital signature on a user interface made available to the user on his/her network enabled device. The digital signature created by the user is also stored in the repository 14 for further processing and verification.

In another embodiment, the server 10 optionally modifies the notification message to be sent to the user for confirming his identity. For example, after the end of the message body, a web link or a web page address can be inserted by the server 10, using which the user can confirm his/her identity. Further, the message may also be modified by the server 10 in such a way that the message enables the user to go to a website by clicking on the hyperlink available as a part of the message, and subsequently compose a new message or reply to the received message, thereby confirming his/her identity.

In accordance with the present disclosure, for every electronic form being distributed to remote users, the server 10 creates a unique code/unique identification number corresponding to the respective electronic forms. The unique code can be a timestamp indicating the time at which the electronic form was sent to the remote user from the server 10. The unique code is also stored in the repository 14 for future reference. The unique code/identification number can also be embedded in the notification message that is sent to the remote user from the server 10, for confirmation of remote user's identity. For example, the “FROM” field of the message can be augmented to contain the unique code of the electronic form along with the email address of the remote user (address of remote user receiving the replica of the electronic form with data fields). Further, the unique code/identification code can also be embedded in the return mail sent by the remote user confirming his/her identity to the server 10.

In another embodiment, a digital signature can be obtained, using well known techniques, on the filled-up/completed electronic form, by the server 10. The electronic form to be transmitted to the designated requesting user can be combined with the indication(s) of the remote user(s) filling up/completing the form, and subsequently a digital signature can be obtained on the aforementioned combination prior to transmitting the same to the requesting user. The server 10 further creates a timestamp indicating the time at which the filled-up/completed electronic form was transmitted to the requesting user. The time stamp is stored in the repository 14 for further reference.

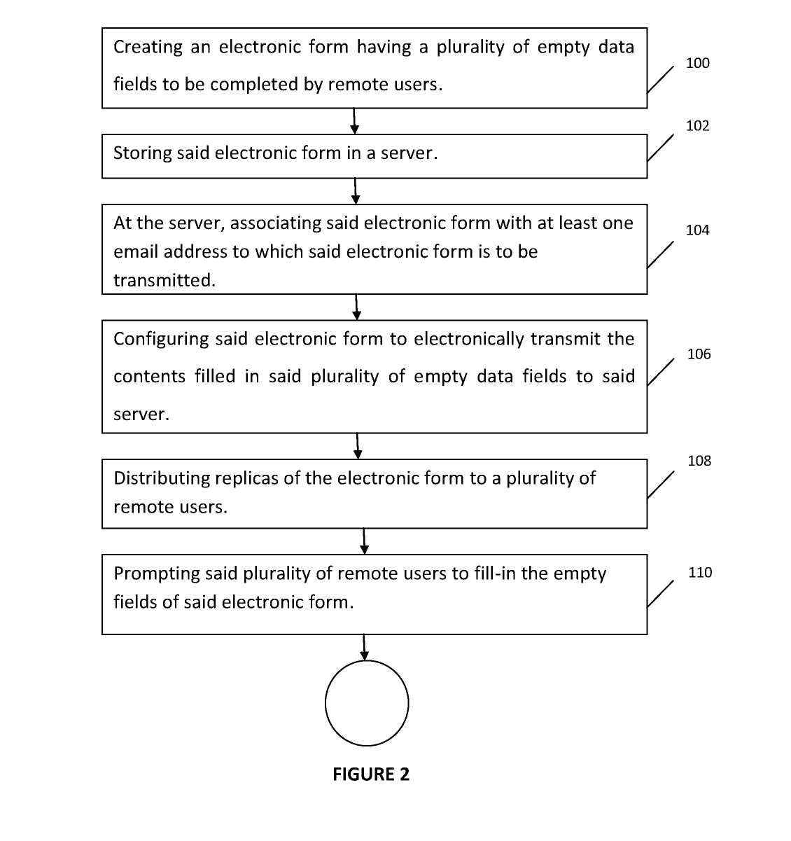

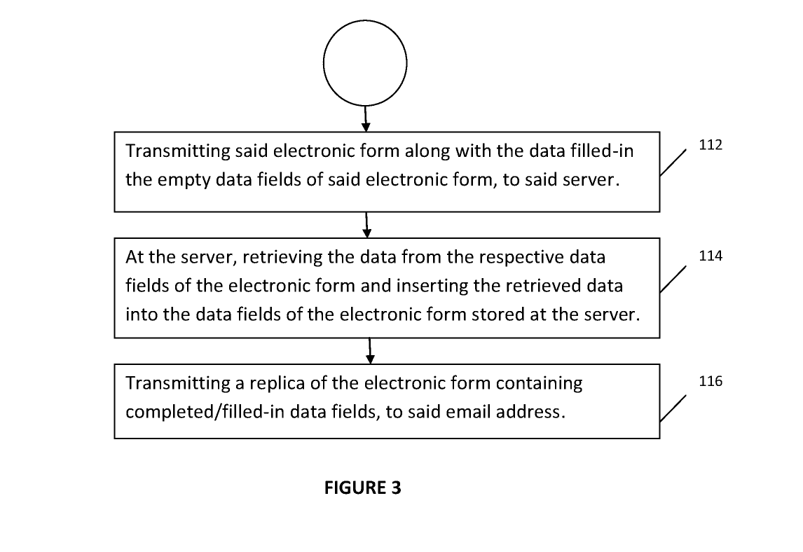

Referring to FIG. 2 and FIG. 3, there is shown a flowchart illustrating one embodiment of a method for collection, aggregation and authentication of electronic data provided by remote users through distributed electronic forms. The method includes the following computer implemented steps:

In box 100, an electronic form having a plurality of data fields to be completed by remote users is created. The electronic forms are stored in a memory associated or in communication with in a server in box 102.

The electronic form is associated at the server with at least one email address to which the electronic form is to be transmitted in box 104

In box 106, the electronic form is configured to electronically transmit the contents filled in the plurality of data fields of the electronic form to the server.

Replicas of the electronic form are distributed to a plurality of remote users in box 108.

Remote users are prompted to fill-in the fields of the electronic form in box 110.

The electronic form is transmitted along with the data filled-in the data fields of the electronic form to the server in box 112.

The data from the respective data fields of the electronic form is retrieved at the server and inserted into the data fields of the electronic form stored at the server in box 114.

A replica of the electronic form containing the completed/filled-in data fields is transmitted to the email address in box 116.

Another embodiment of the present inventions includes a method having the following computer implemented steps: receiving at the server, an email address corresponding to a requesting user to whom the electronic form containing completed/filled-in data fields, is to be sent; sending a message to the requesting user for confirming the identity of the requesting user; and transmitting the completed/filled-in electronic form to the requesting user only in the event a confirmation of the identity of the remote user is received by the server.

In another embodiment, the step of sending a message to the requesting user for confirming the identity of the requesting user further may include the step of sending an email message to the requesting user. In still another embodiment of the present invention, the method may include the step of transmitting the completed/filled-in electronic form to the requesting user and further includes the step of transmitting the completed/filled-in form as an attachment to an email message.

In accordance with the present disclosure, the method further includes the step of transmitting the electronic form to an internet based website/web service.

In yet another embodiment of the present disclosure, the method further includes the following computer implemented steps: generating a unique identification code corresponding to the electronic form completed/filled-in by a remote user; and embedding the identification code in the message transmitted to the remote user for confirmation of identity of the remote user.

Further, the computer implemented method may include the step receiving a reply from the remote user filling-in/completing the electronic form, in the form of return email message.

In another embodiment, the computer implemented method further may include the step of embedding a web link into the email message sent to the remote user for confirmation of identity. In still another embodiment, the method further includes the step of pointing/referring through the web link to the unique identification code corresponding to the electronic form completed/filled-in by the remote user. In an alternative embodiment, the method my further include the step of prompting the remote user to visit a website associated with the server to provide indications of identity.

Another embodiment of the present invention include a computer implemented method further includes the following computer implemented steps: prompting the remote user filling/completing the electronic form, to draw a signature in a web-interface as an indication of the remote user's identity; and recording a copy of the signature at the server as a confirmation of the identity of the remote user.

In accordance with the present disclosure, the method further includes the step of embedding the unique identification code in the return email message sent by the remote user confirming his/her identity.

In accordance with the various embodiments of the computer implemented methods disclosed herein, the method may further include the step of including indicia confirming the identity of the remote user in the copy of the filled-in/completed form transmitted to the requesting user designated to receive the filled-in/completed electronic form. In another embodiment, the method further includes the step of creating a digital signature on the combination of filled-in/completed electronic form along with indications of the identity of the remote user filling/completing the form, prior to transmitting the electronic form to the designated requesting user.

The present invention is also embodied in a system including a processor having at least one processor and a memory in communication therewith, along with suitable communication abilities to provide for the distribution of forms to remote users, as well as retrieval of the information entered in the data fields of those forms by the remote users. The at least one processor of the server is programmed using software commands to carry out the various embodiments of the methods described above.

Various other embodiments of the methods described above may also include the step of associating a time stamp indicative of the time the completed/filled-in electronic form is transmitted to the designated requesting user, and/or further including the step of basing the electronic form upon Portable Document Format (PDF).

The various embodiments of the system and method of the present invention are advantageous in that the provide a method that enables collection and aggregation of data obtained from remote users and that can be seamlessly integrated with currently available data collection methods, facilitating easy collection of data from remote users. Moreover, those embodiments provide a system and method that generates a unique identification code uniquely identifying the data provided by a user and facilitates authentication of a remote user's identity before sending the acquired data. The ease of use of the various embodiments of the present invention is also enhanced by providing a method that prompts the user providing the data, to draw a signature in a web-interface as an indication of the user's identity.

While considerable emphasis has been placed herein on the various components of the preferred embodiment, it will be appreciated that many alterations can be made and that many modifications can be made in the preferred embodiment without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

I claim:

1. A computer implemented method for collection, aggregation and authentication of electronic data provided by remote users through distributed electronic forms, the method comprising:
creating an electronic form having a plurality of data fields to be completed by remote users;
storing the electronic form in a server;
at the server, associating the electronic form with at least one email address to which the electronic form is to be transmitted;
configuring the electronic form to electronically transmit the contents filled in the plurality of data fields to the server;
distributing replicas of the electronic form to a plurality of remote users;
prompting the plurality of remote users to fill-in the fields of the electronic form;
transmitting the electronic form along with the data filled-in the data fields of the electronic form, to the server;
at the server, retrieving the data from the respective data fields of the electronic form and inserting the retrieved data into the data fields of the electronic form stored at the server; and
transmitting a replica of the electronic form containing completed/filled-in data fields to the email address.

2. The computer implemented method as claimed in claim 1, wherein the method includes the following computer implemented steps:
receiving at the server, an email address corresponding to a requesting user to whom the electronic form containing completed/filled-in data fields is to be sent;
sending a message to the requesting user for confirming the identity of the requesting user; and
transmitting the completed/filled-in electronic form to the requesting user only in the event a confirmation of the identity of the remote user is received by the server.

3. The computer implemented method as claimed in claim 2, wherein the step of sending a message to the requesting user for confirming the identity of the requesting user further includes the step of sending an email message to the requesting user.

4. The computer implemented method as claimed in claim 2, wherein the step of transmitting the completed/filled-in electronic form to the requesting user further includes the step of transmitting the completed/filled-in form as an attachment to an email message.

5. The computer implemented method claimed in claim 1, wherein the method further includes the step of transmitting the electronic form to an internet based website/web service.

6. The computer implemented method as claimed in claim 3, wherein the method further includes the following computer implemented steps:
generating a unique identification code corresponding to the electronic form completed/filled-in by a remote user; and
embedding the identification code in the message transmitted to the remote user for confirmation of identity of the remote user.

7. The computer implemented method as claimed in claim 2, wherein the method further includes the step of receiving a reply from the remote user filling-in/completing the electronic form in the form of a return email message.

8. The computer implemented method as claimed in claim 3, wherein the method further includes the step of embedding a web link into the email message sent to the remote user for confirmation of identity.

9. The computer implemented method as claimed in claim 7, wherein the method further includes the step of pointing/referring through the web link, to the unique identification code corresponding to the electronic form completed/filled-in by the remote user.

10. The computer implemented method as claimed in claim 2, wherein the method further includes the step of prompting the remote user to visit a website associated with the server to provide indications of identity.

11. The computer implemented method as claimed in claimed in claim 10, wherein the computer implemented method further includes the following computer implemented steps:
prompting the remote user filling/completing the electronic form to draw a signature in a web-interface as an indication of the remote user's identity; and
recording a copy of the signature at the server as a confirmation of the identity of the remote user.

12. The computer implemented method as claimed in claim 10, wherein the method further includes the step of embedding the unique identification code in the return email message sent by the remote user confirming his/her identity.

13. The computer implemented method as claimed in claim 1, wherein the method further includes the step of including indicia confirming the identity of the remote user in the copy of the filled-in/completed form transmitted to the requesting user designated to receive the filled-in/completed electronic form.

14. The computer implemented method as claimed in claim 11, wherein the method further includes the step of creating a digital signature on the combination of filled-in/completed electronic form along with indications of the identity of the remote user filling/completing the form, prior to transmitting the electronic form to the designated requesting user.

15. The computer implemented method as claimed in claim 11, wherein the method further includes the step of associating a time stamp indicative of the time the completed/filled-in electronic form is transmitted to the designated requesting user.

16. The computer implemented method as claimed in claim 1, wherein the method further includes the step of basing the electronic form upon Portable Document Format (PDF).

17. A system for collection, aggregation and authentication of electronic data provided by remote users through distributed electronic forms, comprising:
a server having a processor associated with a memory, the processor programmed by software commands to:
create an electronic form having a plurality of data fields to be completed by remote users,
store the electronic form in the memory,
associate the electronic form with at least one email address to which the electronic form is to be transmitted,
configure the electronic form to electronically transmit the contents filled in the plurality of data fields to the server,
distribute replicas of the electronic form to a plurality of remote users through a communication network,
prompt the plurality of remote users to fill-in the fields of the electronic form,
receive the electronic form along with the data filled-in the data fields of the electronic form,
retrieve the data from the respective data fields of the electronic form and insert the retrieved data into the data fields of the electronic form stored in the memory; and
transmit a replica of the electronic form containing completed/filled-in data fields to the email address.

18. The system of claim 17, wherein the processor is further programmed by software commands to generate a unique identification code corresponding to the electronic form completed/filled in by a remote user and to embed the identification code in a message transmitted to the remote user for confirmation of identity of the remote user.

19. The system of claim 17, wherein the processor is programmed by software commands to receive a reply form the remote user filling-in/completing the electronic form in the form of a return email message.

20. The system of claim 17, wherein the processor is programmed by software commands to send a message having an embedded link which can be activated by the remote user to confirm the identity of the remote user.
